(19) United States
(12) Patent Application Publication
(10) Pub. No.: US 2021/0088226 A1
(43) Pub. Date: Mar. 25, 2021

(54) THERMAL TRANSFER PANEL SYSTEM

(71) Applicant: J. Parr Wiegel, Pittsford, NY (US)

(72) Inventor: J. Parr Wiegel, Pittsford, NY (US)

(21) Appl. No.: 16/580,519

(22) Filed: Sep. 24, 2019

(51) Int. Cl. F24D 3/14; B29C 51/10; B29C 65/70; F24D 3/12; B32B 3/20

(52) U.S. Cl. CPC F24D 3/148; B29C 51/10; B29C 65/70; B29L 2031/779; F24D 3/146; B32B 3/20; F24D 3/122

(57) ABSTRACT

A thermal transfer panel is provided, wherein the thermal transfer panel is vacuum formed from separate precursor sheets to form an integral thermal transfer panel. The integral thermal transfer panel defines both fluid flow channels and an interconnecting web, wherein the interconnecting web defines a structure or fastening beam for accommodating fasteners than can retain the thermal transfer panel relative to a building structure, such as a joist. The thermal transfer panel includes surface indicia to allow an installer to determine the location of at least one of the fluid flow channel and the interconnecting web in the thermal transfer panel. Traditional flooring can be fastened to the thermal transfer panel without damaging the integrity of the fluid flow channel.

### FIELD OF THE INVENTION

The present disclosure relates generally to a system that utilizes a thermally conditioned fluid, such as a heated fluid (water, glycol, antifreeze or other liquid or combination) to impart heat transfer into or out of an internal or external structure such as subfloor, floor, roof, outdoor patio or driveway section. More specifically, the present disclosure is directed to a dual sheet thermoformed polymeric panel with specific fluid channels to enable the thermally conditioned fluid to impart thermal transfer to/from the surrounding material of the panel and thus impart thermal transfer into the structure, and even more specifically, a dual sheet thermoformed panel formed under heat and pressure to form an integral thermal transfer panel that allows the thermally conditioned fluid, such as heated liquid (water, glycol, antifreeze or other liquid or mixture) to be used in heating the inside of a home, apartment, building, shed or other structure including but not limited to floors, walls and roofs in an efficient manner.

### DESCRIPTION OF RELATED ART

There are many areas within a home, building, shed or other structures where heating can take place in a more efficient manner than as provided by conventional systems. Forced air and baseboard heat are two examples of conventional systems. By increasing the efficiencies of heating delivery systems to a home, building, shed or other structures with a radiant heating panel there is a significant reduction in fuel usage, thereby significantly abating fuel costs, pollution created by burning fossil fuels and other natural resources. Additionally, reducing fuel costs may directly impact energy costs by reducing demand and increasing supply.

One area of a home, building, shed or other structures that operates inefficiently is a forced air heating system. The very best forced air systems are 85% efficient as the heat source and lost heat in the wall or floor transfers some of the heat which is then pushed into a room or other space creating a circular airflow which further cools the air and reduces efficiency.

Another area of the home, building, shed or other structures that heats inefficiently is baseboard heating, while radiant heating is efficient, base boards are limited in size output. In addition, baseboard heat tends to heat only the area directly above the heat source creating hot and cold spots within a room or space.

What is needed is a radiant thermal transfer panel system that will heat the entire floor, or wall of a room or space offering a very accurate and consistent heating system eliminating hot and cold spots and reducing fuel usage.

### SUMMARY OF THE INVENTION

In one configuration, the present disclosure provides a thermal transfer panel having a top plate and a bottom plate, the top plate being integral with the bottom plate to define a continuous fluid flow channel extending between the top plate and the bottom plate, the fluid flow channel extending between a first port and a second port, wherein the fluid flow channel is defined by bonded portions of the top plate and the bottom plate forming an interconnecting web, the top plate defines a top surface of the thermal transfer panel and the bottom plate defines a bottom surface of the thermal transfer panel; and a fastening beam defined by bonded portions of the top plate and the bottom plate, the fastening beam spaced from the fluid flow channel. In one configuration, the bottom plate defines at least one external groove for receiving a structural building element.

In a further configuration, the present disclosure provides a method of making a radiant thermal transfer panel, the method include the steps of (a) vacuum forming a first precursor sheet in a first thermoforming mold; (b) vacuum forming a second precursor sheet in a second thermoforming mold; and (c) moving the first thermoforming mold relative to the second thermoforming mold to contact a portion of the first precursor sheet with a first portion of the second precursor sheet, such that the first portion of the first precursor sheet bonds with the first portion of the second precursor sheet to form an integral panel having a top plate and a bottom plate, wherein the first precursor sheet forms the top plate and the second precursor sheet forms the bottom plate of the integral panel and the integral panel defines a fluid flow channel having a first port and a second port.

### BRIEF DESCRIPTION OF THE SEVERAL VIEWS OF THE DRAWINGS

FIG. 1 is a representative view of prior art sub-flooring being installed on a plurality of floor joists.

FIG. 2 is a perspective view of prior art PEX tubing attached to a subfloor.

FIG. 3 is a perspective view of the present dual formed thermal transfer panel relative to a plurality of supports.

FIG. 4 is an enlarged perspective view of the present dual formed thermal transfer panel of FIG. 3.

FIG. 5 is a cross sectional view of the present dual formed thermal transfer panel of FIG. 3.

FIG. 6 is a schematic representation of a formed top sheet and a formed bottom sheet prior to bonding to form respective top plate and bottom plate in the dual formed thermal transfer panel.

FIG. 7 is a schematic representation of the bonded top sheet and bottom sheet of FIG. 6 forming the respective top plate and bottom plate in the dual formed thermal transfer panel.

FIG. 8 is a perspective view of an alternative exterior configuration of the dual formed thermal transfer panel.

FIG. 9 is an enlarged view of a portion of FIG. 8.

FIG. 10 is side elevational view of a coupler for interconnecting fluidly and mechanically thermal transfer panels.

FIG. 11 is cross sectional view of a portion of the thermal transfer panel having mating features for engaging a coupler.

FIG. 12 is side elevational view of an alternative coupler, such as for engaging a supply or return line.

FIG. 13 is a side elevational view of a coupler that can function as a plug to terminate a flow channel in the thermal transfer panel.

FIG. 14 is a perspective view of a first precursor sheet and a second precursor sheet in respective molds, with a vacuum pulling the plastic into the respective mold.

FIG. 15 is a perspective view of a first precursor sheet and a second precursor sheet in the respective molds being brought together to bond a side of the first precursor sheet with a side of the second precursor sheet, thereby forming the corresponding plates and the fluid flow channels.

FIG. 16 is an enlarged perspective view of a first precursor sheet and a second precursor sheet in the respective molds being brought together to bond a side of the first precursor sheet with a side of the second precursor sheet, thereby forming the corresponding plates and the fluid flow channels.

FIG. 17 is a perspective view of a first precursor sheet and a second precursor sheet from the respective molds being bonded together, thereby forming the corresponding plates and the fluid flow channels.

FIG. 18 is an enlarged perspective view of a first precursor sheet and a second precursor sheet from the respective molds being bonded together, forming the corresponding plates and the fluid flow channels.

### DESCRIPTION OF THE PREFERRED EMBODIMENTS

The present disclosure provides a dual sheet thermoformed thermal transfer panel 10, wherein the thermal transfer panel can be operably located in a home, a building, a shed or other structure to function as a heat source or a heat sink. It understood the thermal transfer panel 10 can be warmer than the surrounding environment thereby acting as a heat source and transferring heat to the surrounding environment or the thermal transfer panel can be cooler than the surrounding environment acting as a heat sink and transferring heat from the surrounding environment. For purposes of description, the thermal transfer panel 10 is set forth in terms of acting as a heat source, but it is understood the present description is applicable to the thermal transfer panel functioning as a heat sink. Further, it is understood the thermal transfer panel 10 can be operably deployed in a home, building, shed or other structure. For purposes of convenience the thermal transfer panel 10 is referred to as being operably located in a house, but this is not limiting in the operable location of the thermal transfer panel. The thermal transfer panels 10 heat up and retain heat so once the thermal transfer panel is relatively hot, the panel will continue to heat the floor longer, in contrast to air or wood.

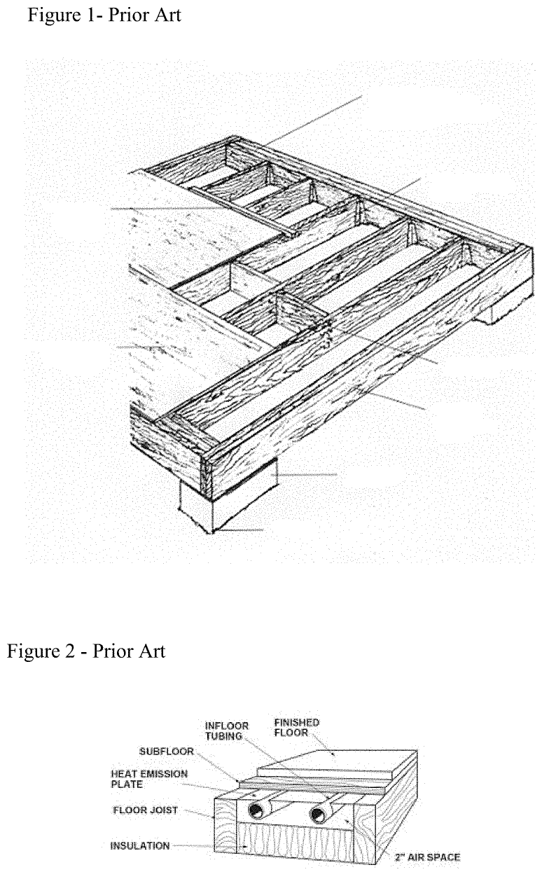

Referring to FIGS. 1 and 2, existing subfloors and roofs are installed in generally the same manner. Joists are put in place and supported by load bearing walls. Once the joists are in place, subflooring, such as particle board or plywood is glued and nailed to the joists creating a subfloor surface. This subflooring has no independent heating capabilities.

As seen in FIG. 2, in an effort to create a heated radiant surface, prior systems attach a PEX (cross-linked polyethylene) tubing to the subfloor. However, these prior methods create little direct contact (or thermal contact) between the PEX tubing and the floor or subfloor. This low thermal conductivity between the PEX tubing and the floor or subfloor causes inefficiencies in heat transfer, yet this method is still more efficient than forced air.

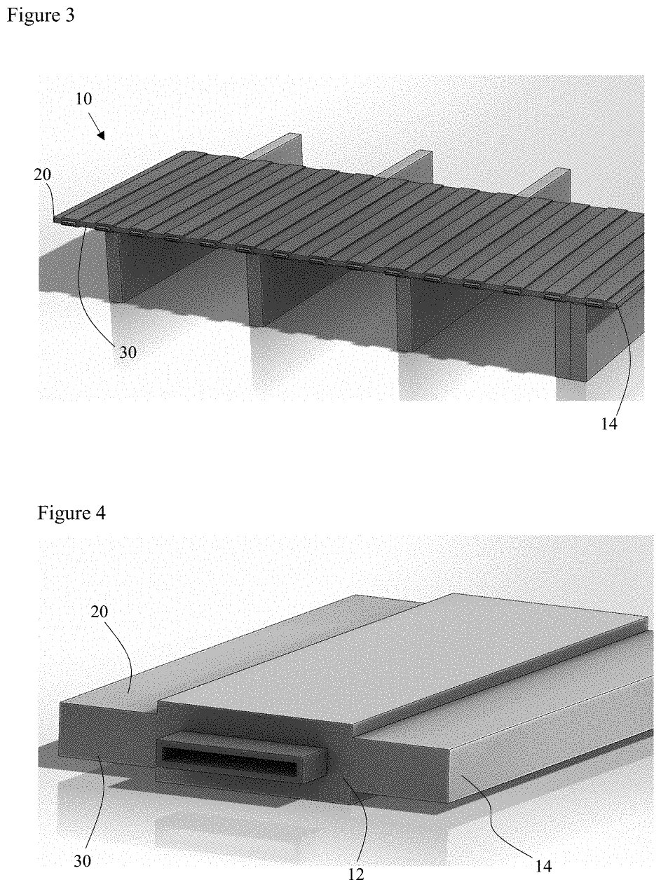

Referring to FIG. 3, the present thermal transfer panel 10 includes a top plate 20 and a bottom plate 40 which define at least one fluid flow channel 70 therebetween. The thermal transfer panel 10 further includes an interconnecting web 12 forming solid bonded areas of the top plate 20 and the bottom plate 30 (defining the non-fluid flow channels of the thermoformed thermal transfer panel) which effectively function as radiant heat transfer areas that absorb heat from the fluid flow channel and transfer the heat into the adjacent space or room.

The thermal transfer panel 10 thus includes a top surface 22, a bottom surface 42, a peripheral wall 14 connecting the top surface to the bottom surface along with a first port 72 and a second port 74 communicating with the fluid flow channel 70. It is contemplated the first port 72 and the second port 74 can be located in the peripheral wall 14 or at least one of the top surface 22 and the bottom surface 42.

In one configuration, at least a portion of the top surface 22 of the top plate 20 and/or the bottom surface 42 of the bottom plate 40 includes indicia or markings 60 indicating the location of at least one of the fluid flow channel 70 and the interconnecting web 12. The indicia 60 allows an installer to locate a fastening or nailing area, where fasteners can penetrate the thermal transfer panel 10 and engage a supporting structure such as a joist, rafter or stud, without intersecting the fluid flow channel 70. The indicia 60 can include recesses or depressions, typically on the order of 0.1 inch of less. In a further configuration, the indicia 60 can include a textured or embossed surface.

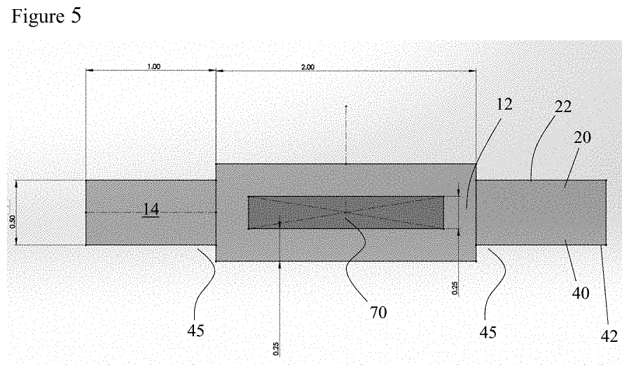

In one configuration shown in FIGS. 3-7, the bottom surface 42 of the bottom plate 40 is designed to fit on and engage a floor or roof joist or stud, particularly as such joists are used to support a sub floor or sub roof. For example, the bottom plate 40 defines at least one external groove 45 for receiving a structural building element. The structural building element includes joists, studs, rafters or any other building component. Thus, the thermal transfer panel 10 will replace the sub floor or sub roof. For example, the bottom surface 42 of the bottom plate 40 includes grooves or recesses 45 for receiving a portion of the respective joist. For example, if the thermal transfer panel 10 is to operably engage a typical 2×6; 2×8, 2×10 or 2×12 floor joist, as the joist has a nominal thickness of approximately 1.5 inches, then the groove 45 in the bottom surface 42 of the bottom plate 40 has a width of approximately 1.5 to 1.6 inches to receive the joist. The depth of the groove 45 can be between approximately ⅛ inch to one inch, though the depth of the groove is not limiting.

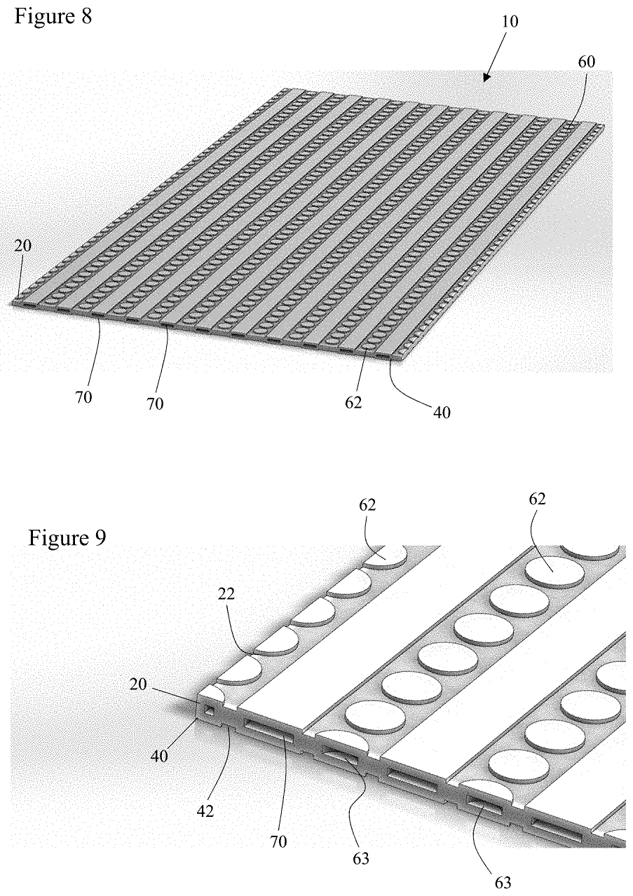

Referring to FIGS. 8 and 9, in an alternative configuration, the surface of the thermal transfer panel 10 includes raised pads 62 indicating the location of the interconnecting web 12 for receiving fasteners for securing the thermal transfer panel to the building structure. As seen in this configuration, the interconnecting web 12 can include discrete pockets 63 corresponding to the raised pads 62 on the outside surface. The pockets 63 can provide for a reduction in weight of the thermal transfer panel 10 as well as function as a local thermal resistance.

The interconnecting web 12 can form a fastening beam 16 for receiving and or passing a fastener to operably locate the thermal transfer panel 10 relative to the respective building structure. For example, the fastening beam 16 can engage a fastener such as a nail, screw or bolt as well as provide a fastening surface for an adhesive bonding either to joists or a subfloor material. In one configuration, the fastening beam 16 is formed by solid material extending between the top surface 22 of the top plate 20 and the bottom surface 42 of the bottom plate 40.

As seen in FIG. 3, in one configuration, the thermal transfer panel 10 is placed on the floor joist and a second thermal transfer panel (not shown) is fluidly connected to the first thermal transfer panel through couplers 80, wherein the couplers allow liquid flow between the thermal transfer panels 10. Once the room or space is completed, a manifold (not shown) provides the fluid distribution and return to and from the connected thermal transfer panels 10 to the thermal conditioning system, heating system, allowing the entire grouping of the thermal transfer panels to become a highly efficient complete heating system.

The couplers 80 are connection devices that make both the structural connection and the fluid connection between the fluid flow channels 70 of adjacent thermal transfer panels 10, thereby holding the thermal transfer panels together and allowing the thermally conditioned fluid to transfer between thermal transfer panels. In one configuration, the coupler 80 includes a first end 82 having engaging surfaces for mechanically and sealingly engaging the thermal transfer panel 10 and a second end 84 for operably connecting to a commercially available line such as, but not limited to standard industry PEX tubing in one configuration or another thermal transfer panel in a second configuration. In a further configuration, it is contemplated the coupler 80 can be structured to function as a plug.

It is contemplated that each end of the fluid flow channel 70 includes the fluid flow channel interface (port) for operably receiving the coupler 80, wherein the coupler fluidly connects to the fluid flow channel interface of a second thermal transfer panel 10, thereby operably fluidly interconnecting the thermal transfer panels. The thermal transfer panel 10 can be formed to fit the size of a given room and the couplers 80 or end plugs are inserted into the thermal transfer panel. The couplers 80 thus allow the fluid flow channel 70 to create a supply and return within each thermal transfer panel 10.

As set forth above, each end of the fluid flow channel includes the port 72, 74 defining a fluid flow channel interface for operably receiving the coupler 80, wherein the coupler fluidly connects to the fluid flow channel interface of a second thermal transfer panel, thereby operably fluidly interconnecting the thermal transfer panels. Depending on the specific configuration of the installation, a given port 72, 74 can be a return port or an inlet port. The port 72, 74 can be located along a periphery edge of the thermal transfer panel or at one of the major planar faces of the panel. Further, as set forth below the ports 72, 74 can be located at adjacent or opposing peripheral edges or walls 14 of the thermal transfer panel 10. It is also contemplated the ports 72, 74 may be located along a common peripheral edge 14 of the thermal transfer panel 10.

While the figures disclose the configuration wherein the couplers 80 mechanically connect adjacent thermal transfer panels 10, it is contemplated that alternative types of interconnection can be employed for joining the coupler to the thermal transfer panel as well as adjacent thermal transfer panels, such as bonding including cements and bonding agents or welding such as ultrasonic welding.

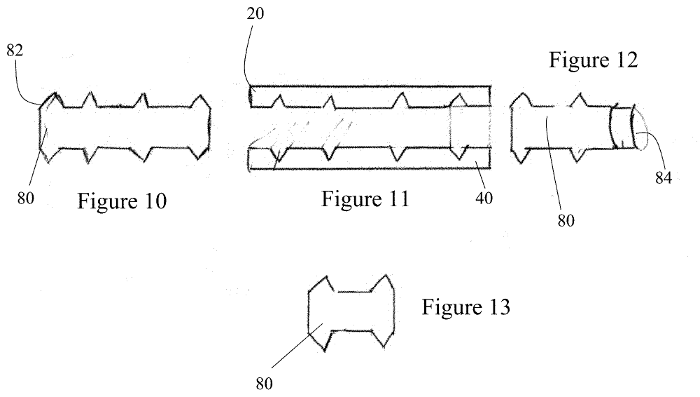

As seen in FIGS. 10-13, the couplers 80 and the port 72, 74 of the thermal transfer panel 10 can be cooperatively configured to provide operable interconnection. Thus, the coupler 80 can function as a fluid connection into/out of the thermal transfer panel 10, a mechanical connection between thermal transfer panels as well as termination of flow channels. In one configuration, an exterior surface of the coupler 80 and a corresponding surface of the port 72, 74 include mating surface features such as but not limited to ridges—grooves, concave portion—convex portions as well as threaded surfaces. These allow the coupler 80 to be operably engaged with the port 72, 74 and hence thermal transfer panel 10 so as to provide the intended fluid, structural or fluid and structural connection. It is further contemplated that adhesives, bonding agents as well as welding or ultrasonic welding can be used to connect the coupler 80 to the thermal transfer panel 10.

The ports 72, 74 and associated couplers 80 can be located to provide any of a variety of flow channel patterns. For example, the dual formed thermal transfer panel 10 can have the fluid flow channels 70 in a diagonal pattern. In this pattern, the supply/return ports 72, 74 can be located at opposing diagonal corners of the thermal transfer panel 10. It is understood the ports 72, 74 can be located along a common edge of the rectangular thermal transfer panel 10. The couplers 80 can provide at least a portion of the mechanical connection between adjacent thermal transfer panels 10 by holding the adjacent thermal transfer panels together and can provide fluid communication between the thermal transfer panels allowing the heated or cooled fluid to transfer between thermal transfer panels. As set forth above, the interconnecting web 12 of the thermal transfer panels 10 can define a radiant heat area that absorbs and transfers heat into the adjacent environment, such as a room.

In addition, the port 72, 74 (and hence coupler 80) can have a different cross sectional profile than the remainder of the flow channel 70. For example, the coupler 80 and port 72, 74 can have a curvilinear or circular cross section while the flow channel 70 has a faceted or rectangular cross section. However, it is understood the coupler 80 and port 72, 74 can have a faceted or rectangular cross section while the flow channel 70 has a curvilinear or circular cross section.

As set forth above, the thermal transfer panel 10 includes the top surface 22, the bottom surface 42 and the peripheral wall 14 connecting the top surface to the bottom surface and the first port 72 and the second port 74 are located in the peripheral wall. It is also contemplated the first port 72 and the second port 74 are located in one of the top surface 22 and the bottom surface 42. Further, both the first port 72 and the second port 74 are located in the top surface 22, the bottom surface 42, the peripheral wall 14 or any combination thereof.

The fluid flow channel 70 is defined by portions of the top plate 20 bonding to corresponding portions of the bottom plate 40 thereby forming the interconnecting web 12 which partly defines the fluid flow channel.

In one configuration, the only spaced portions of the top plate 20 and the bottom plate 40 define the fluid flow channels, such that the remainder of the thermal transfer panel 10 is solid material. However it is understood, the interconnecting web 12 can define the fluid flow channels 70 as well as separate hollow portions 63 of the thermal transfer panel, wherein the hollow portions, or pockets, do not transmit fluid flow. The pockets 63 provide for a reduced weight and materials cost of the thermal transfer panel 10. However, as such hollow portions 63 act as a thermal insulator, it is believed advantageous for the top plate 20 and the bottom plate 40 to be bonded over their entire area, except where the fluid flow channel 70 is formed. While the polymer material forming the top plate 20 and the bottom plate 40 are solid, it is understood in some configurations, the material of the top plate and/or the bottom plate can be partly foamed or cellular, thereby reducing weight and material cost. Again, these benefits are balanced against the objective of the thermal transfer panel 10 providing thermal transfer—which is enhanced by the top plate 20 and the bottom plate 40 being a solid member except of the defined fluid flow channels 70.

The fluid flow channels 70 are thus defined by (i) portions of the top plate 20 that are spaced from portions of the bottom plate 40 and (ii) the adjacent interconnecting web 12. It is contemplated the fluid flow channel 70 can be any of a variety of cross-sectional profiles including but not limited to faceted, curvilinear, oval, obround, square, rectangular or circular. The fluid flow channels 70 can be symmetrical or non-symmetrical relative to a longitudinal axis of the fluid flow channel or relative to a transverse direction to the longitudinal axis. That is, while the fluid flow channel 70 can have a constant cross sectional area along the longitudinal axis, the fluid flow channel can vary from circular or square, for example 2 inch diameter or dimension to a relative flat channel having a thickness of between 0.25 inches and one inch, thereby defining an area parallel to the top or bottom surface of the panel that can be between approximately 8-10 inches to 3 to 4 inches in width. It is believed that by providing relative large surface areas parallel to the top surface 22 of the top plate 20 or the bottom surface 42 of the bottom plate 40 that heat transfer between the thermal transfer panel 10 and the surrounding environment can be enhanced. The fluid flow channels 70 are centered between the top plate 20 and the bottom plate 40 of the thermal transfer panel 10. However, it is understood the fluid flow channels 70 can be nearer one of the top surface 22 of the thermal transfer panel 10 or the bottom surface 42 of the thermal transfer panel 10. In one configuration, the fluid flow channels 70 are configured to minimize resistance to flow, thereby providing for low pump requirements for circulation. However, it is understood that certain portions of the fluid flow channel 70 may have different resistance to flow.

In one representative configuration, the fluid flow channel 70 has a constant cross section along the longitudinal axis, except at the ports, of an approximately 2 inch width and approximately 2 inch height. Thus, the thermal transfer panel 10 can include the fluid flow channel 70 having a 2″ square fluid channel and a 6″ nailing area (defined by the fastening beam 16 of interconnecting web 12) between lengths of the fluid flow channel is contemplated. In such configuration, the radiant heat should be even across the 6″ section creating an optimum thermal transfer surface.

Manufacture

In one configuration of the thermal transfer panel 10, the bottom plate 20 (or wall) and the top plate 40 (or wall) are fused together during a dual sheet thermoforming process.

That is, an independent first precursor sheet 24 (which results in the first or top plate 20) and a second precursor sheet 44 (which results in the second or bottom plate 40) are combined to form the dual sheet thermal transfer panel 10 defining a fluid flow channel 70. The thermal transfer panel 10 defining the fluid flow channel 70 is created when the first precursor sheet 24 (top plate) and second precursor sheet 44 (bottom plate) are combined through the process of dual sheet thermoforming. During the thermoforming process, precursor sheet 24 (top plate) and precursor sheet 44 (bottom plate) are created simultaneously by disposing, such as pouring, a polymer, such as a hot plastic (or other) onto a vacuum form mold. Depending on the intended operating environment and selected materials of construction, the thickness of the thermal transfer panel 10 can be between approximately 1/16 inch to 6 inches or more. Once the first precursor sheet 24 (top plate) and second precursor sheet 44 (bottom plate) are fully poured, a vacuum is pulled under each sheet (plate). The application of a vacuum gives the ability of the mold to be moved, such as having the mold halves pressed together while the polymer is still in a formable, such as semi-molten. This process in which the precursor sheets 24, 44 are vacuumed to their respective mold and the molds are then pushed together while still heated, allows the integral bonding of the sheets to form a unitary thermal transfer panel 10, wherein the precursor sheets define a respective top plate 20 and a bottom plate 40 in the integrally formed thermal transfer panel. That is, the molecules of the material of each precursor sheet 24, 44, such as plastic, to permanently bond to each other making a very strong integral thermal transfer panel with the fluid channel being integrally formed within.

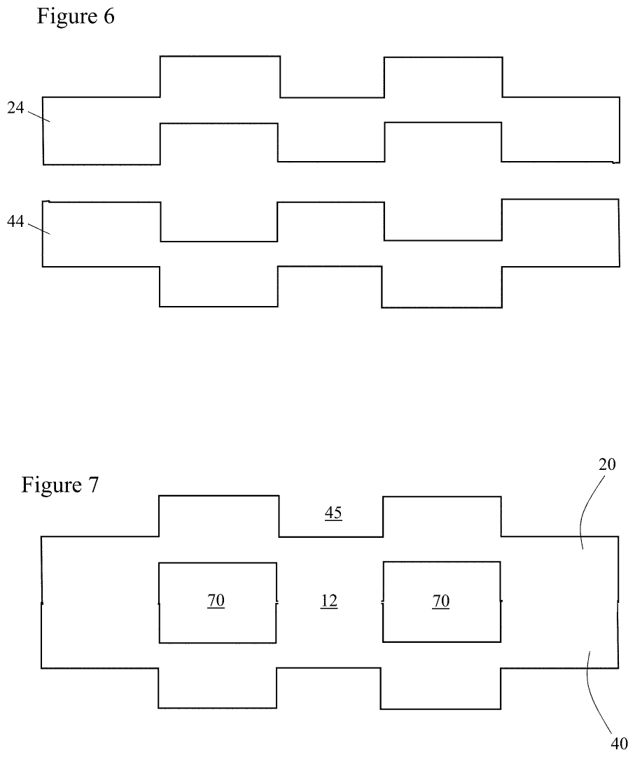

Referring to FIGS. 6 and 7, the first precursor sheet 24 is formed and the second precursor sheet 44 is separately formed. Then the first and second precursor sheets 24, 44 are brought together to bond to form the interconnecting web 12 and hence the fluid flow channels 70. Thus, in one configuration, the first precursor sheet 24 forming the top plate 20 is fused to the second precursor sheet 44 forming the bottom plate 40 during the dual sheet thermoforming process to create the fluid flow channel 70 within the thermal transfer panel 10 between the top surface 22 and bottom surface 42 of the plates as well as creating a supply and a return port 72, 74 within each thermal transfer panel. FIG. 7 shows precursor sheets 24, 44 in a bonded state after the dual sheet thermoforming process has taken place thereby defining the top plate 20 and the bottom plate 40, and showing the fluid flow channel 70 and the interconnecting web 12.

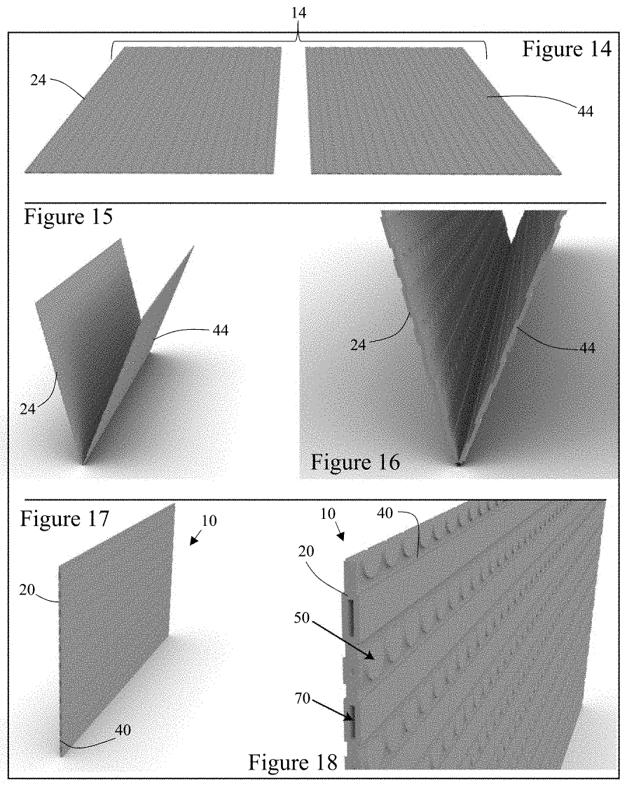

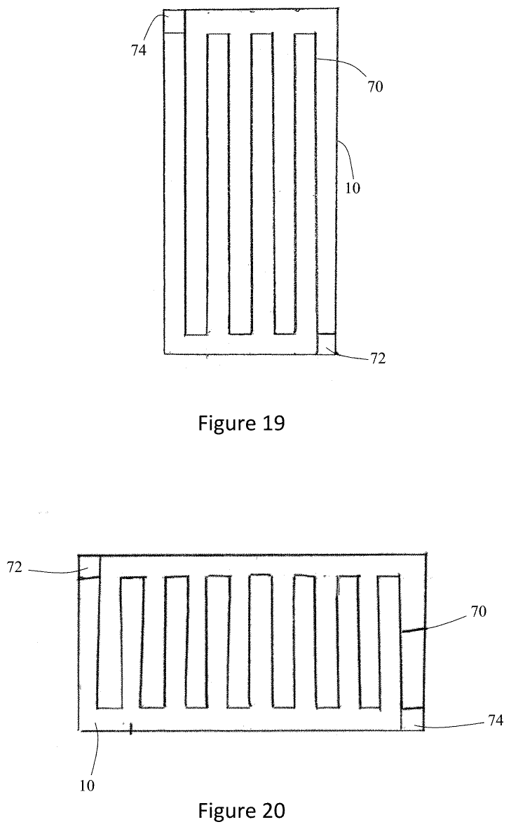

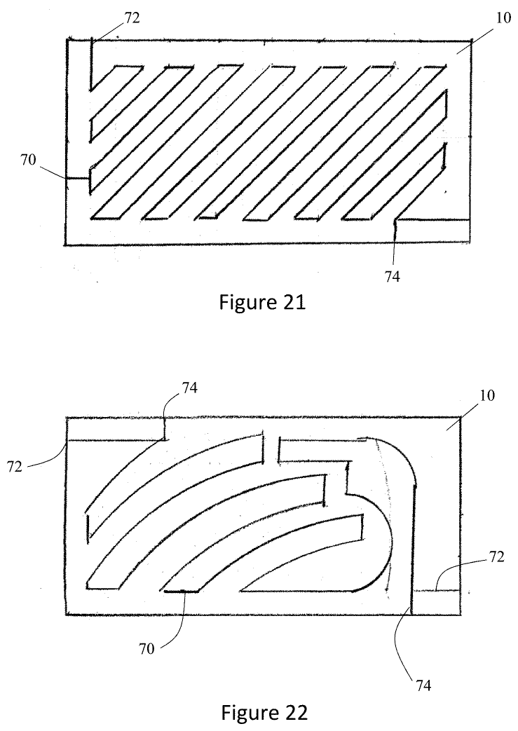

Referring to FIGS. 14-18, a method of manufacturing the thermal transfer panel 10. As seen in FIG. 14, the two precursor sheets 24, 44 are formed by a vacuum pulling the plastic into the respective mold. The mold can be hingedly connected or separate, wherein the molds can be rotated relative to each other. Specifically, as seen in FIGS. 15 and 16, the mold with the first precursor sheet 24 is brought against the mold with the second precursor sheet 44 so that the exposed sides of the precursor sheets contact and bond together. For example, the plastic material can be folded to weld the two precursor sheets together, thereby forming the thermal transfer panel 10 with the fluid flow channel 70, the pockets and the corresponding raised buttons 50 which can receive the fasteners to secure the thermal transfer panel 10 to a structural building member. As seen in FIG. 17, the thermal transfer panel 10 is thus formed as a single solid sheet having the top plate and the bottom plate, wherein the thermal transfer panel can be cut to a smaller size as necessary or interconnected with the couplers 80. FIG. 18 provides an enlarged view of a portion of the thermal transfer panel 10 of FIG. 17 and shows the fluid flow channel 70 and the interconnecting web 12 for receiving fasteners.

Thus, the method of making the thermal transfer panel 10, includes vacuum forming a first precursor sheet 24 in a first thermoforming mold; vacuum forming a second precursor sheet 44 in a second thermoforming mold; and moving the first thermoforming mold relative to the second thermoforming mold to contact a portion of the first precursor sheet with a first portion of the second precursor sheet, such that the first portion of the first precursor sheet bonds with the first portion of the second precursor sheet to form an integral thermal transfer panel 10 having a top plate 20 and a bottom plate 40, wherein the first precursor sheet forms the top plate and the second precursor sheet forms the bottom plate of the integral panel and the integral panel defines a fluid flow channel 70 having a first port and a second port.

The precursor sheets 24, 44 (and hence plates 20, 40, and thus thermal transfer panel 10) can be formed of commercially available polymers, such as but not limited to HDPE (High Density Polyethelene), acrylonitrile styrene acrylate (ASA), thermoplastic polyolefin or olefinic thermoplastic (TPO), fiberglass, polyvinyl chloride (PVC), polyethylene terephthalate (PETE or PET); polyethelene (PE), polypropylene (PP), polystyrene (PS), polylactic acid (PLA), polycarbonate (PC) acrylic (PMMA), acetal (polyoxymethylene, POM), nylon (PA), ABS (Acrylonitrile Butadiene Styrene) and may include additives such as UV stabilizers to increase thermal conductivity or to provide mildew resistance. The precursor sheets 24, 44 can further include strength elements, such as but not limited to fibers or strands including fiberglass and poly-paraphenylene terephthalamide (Kevlar® by E. I. Du Pont De Nemours and Company Corporation. It is further contemplated that the first precursor sheet 24 and the second precursor sheet 44 can be formed of different, but compatible materials, wherein the different sheets will have different R values or thermal conduction. It is contemplated that any other plastic or polymeric material that can be vacuum formed, extruded or pull (or draw) supply and return piping or extrusion to create fluid flow channels 70 within the thermal transfer panel 10 can be employed.

It is contemplated that the thermal transfer panels 10 can be formed to be up to 20 feet wide and as long as desired. Supply and return piping or tubing can be installed at various lengths and attached to the thermal transfer panel 10, after installation of the thermal transfer panel 10 as the sub floor. In one configuration, the thermal transfer panel 10 is formed in a standard size, such as the standard size in the construction industry is a 4×8 foot flooring section. It is anticipated standard sizing will also allow the thermal transfer panels 10 to be used in retrofitting existing structures. However, it is understood the thermal transfer panel 10 can be made to custom sizes as well.

The thermal transfer panels 10 are glued or nailed to the joists in the desired location. As set forth below, the portions of the thermal transfer panel 10 for receiving the nails or glue are demarked or delimited by surface features, textures or colors. Thus, the thermal transfer panels 10 can be affixed to the joists (building framing) in the same manner as existing subfloors. Adjacent thermal transfer panels 10 are interconnected with the couplers 80 as dictated by the respective ports 72, 74 on the thermal transfer panel.

Upon installation of the thermal transfer panels 10, traditional flooring such as but not limited to finish tiles or wood flooring can be joined to the thermal transfer panel 10 in the same manner as they are added to current subfloors. Since the top of the thermal transfer panel 10 includes the indicia 60, the attachment of the flooring can be done without jeopardizing the integrity of the fluid flow channels 70.

In one configuration, the top plate 20 is fused to the bottom plate 40 during the dual sheet thermoforming process to create the fluid flow channel 70 configured within the thermal transfer panel 10 between the top and bottom of the plates creating a supply and return within each thermal transfer panel to and from the thermally conditioned liquid source, such as but not limited to a boiler/water heater/wood stove/etc. Another configuration allows each thermal transfer panel 10 to connect to other thermal transfer panels on all peripheral four edges.

In another configuration of the thermal transfer panel 10, the thermal transfer panel is configured to be subdivided or cut so that portions of the thermal transfer panel can be used in non-standard spacing or locations.

When the thermal transfer panel 10 is used to replace the sub floor in a home, the thermal transfer panel generates a more complete heat transfer which radiates from the entire floor as opposed to wall or floor vents or from radiators and base board heat. When the thermal transfer panel 10 is used as part of a roofing system, the thermal transfer panel can absorb solar energy and circulate solar heated fluid to other thermal transfer panels within the home, thereby further reducing the need to burn fossil fuels and other natural resources as heat sources.

In one configuration, a first thermal transfer panel 10 is placed on the floor joist and a second thermal transfer panel 10 is placed on floor joists and the thermal transfer panels are connected through the couplers 80, wherein the couplers allow fluid flow between the thermal transfer panels. Once the room or space is completed, a manifold (not shown) is operably connected to return and supply lines to distribute and return the fluid to and from the connected thermal transfer panels 10 to the heating system allowing the entire grouping of thermal transfer panels to become a highly efficient complete heating system.

It is contemplated the dual formed thermal transfer panel 10 can be vertically oriented so as to provide a vertical flow pattern, wherein the ports 72, 74 can function as an inlet or outlet as either a supply or return port depending on the flow of fluid through the flow channel. The supply and return ports 72, 74 allow the thermally conditioned (heated or cooled) fluid used in the circuit to enter and return to/from the heat source (or sink), travel into the fluid flow channels 70 as well as pass from one thermal transfer panel 10 to an adjacent thermal transfer panel or a return/supply line.

As set forth above, the dual formed thermal transfer panel 10 can be operably disposed in a horizontal orientation, wherein the flow pattern is correspondingly horizontal, The supply and return ports 72, 74 allow the thermally conditioned fluid (heated or cooled) to enter and return from the heat source, travel into the fluid flow channels 70 as well as pass between the thermal transfer panels 10. The couplers 80 make the connection between the thermal transfer panels 10 holding them together and allowing the heated or cooled fluid to transfer between thermal transfer panels. The interconnecting web 12 defining the volume between the fluid flow channels 70, defines the non-fluid flow channels of the thermoformed thermal transfer panel function as a radiant heat area that absorbs and transfers heat into the adjacent environment, such as a room.

Referring to FIGS. 19-21, the fluid flow channel 70 can be primarily parallel to a longer edge of the thermal transfer panel 10 or a shorter edge of the thermal transfer panel. Alternatively, or in addition, the fluid flow channel 70 can extend diagonally, or inclined relative to the longer and shorter edges of the thermal transfer panel 10. Again, the respective ports 72, 74 can be along the sidewall 14 either on the longer or shorter edge of the thermal transfer panel. It is further contemplated there can be a multiplicity of the ports 72, 74 such that the thermal transfer panel is formed with a port in the sidewall along each edge of the thermal transfer panel, wherein the coupler 80 can function as connectors or plugs in response to the intended operating environment.

In a further configuration, as seen in FIG. 22, the fluid flow channels can define a curvilinear flow pattern. The fluid flow channels can be partly curvilinear or substantially entirely curvilinear, such as 10% of the length to over 95% of the length can be curvilinear.

This disclosure has been described in detail with particular reference to an embodiment, but it will be understood that variations and modifications can be effected within the spirit and scope of the disclosure. The presently disclosed embodiments are therefore considered in all respects to be illustrative and not restrictive. The scope of the invention is indicated by the appended claims, and all changes that come within the meaning and range of equivalents thereof are intended to be embraced therein.

1. A thermal transfer panel comprising:
(a) a top plate and a bottom plate, the top plate integral with the bottom plate to define a continuous fluid flow channel between the top plate and the bottom plate extending between a first port and a second port, wherein the fluid flow channel is defined by bonded portions of the top plate and the bottom plate forming an interconnecting web, the top plate defines a top surface of the panel and the bottom plate defines a bottom surface of the thermal transfer panel; and
(b) a fastening beam defined by bonded portions of the top plate and the bottom plate, the fastening beam spaced from the fluid flow channel.

2. The thermal transfer panel of claim 1, wherein the fastening beam is a portion of the interconnecting web.

3. The thermal transfer panel of claim 1, wherein the fluid flow channel has a curvilinear cross section.

4. The thermal transfer panel of claim 1, wherein a periphery of the thermal transfer panel is rectangular.

5. The thermal transfer panel of claim 4, wherein the first port is located in a first side of the rectangular periphery and the second port is located in a second side of the rectangular periphery.

6. The thermal transfer panel of claim 4, wherein the first port and the second port are located in a first side of the rectangular periphery.

7. The thermal transfer panel of claim 1, wherein an exterior surface of the top plate includes an indicator of a location of at least one of the flow channel and the interconnecting web.

8. The thermal transfer panel of claim 1, wherein a majority of the fluid flow path is curvilinear.

9. The thermal transfer panel of claim 1, wherein a majority of the fluid flow path is linear.

10. The thermal transfer panel of claim 1, wherein the bottom plate defines at least one external groove for receiving a portion of a structural building element.

11. A method of making a thermal transfer panel, the method comprising:
(a) vacuum forming a first precursor sheet in a first thermoforming mold;
(b) vacuum forming a second precursor sheet in a second thermoforming mold; and
(c) moving the first thermoforming mold relative to the second thermoforming mold to contact a portion of the first precursor sheet with a first portion of the second precursor sheet, such that the first portion of the first precursor sheet bonds with the first portion of the second precursor sheet to form an integral thermal transfer panel having a top plate and a bottom plate, wherein the first precursor sheet forms the top plate and the second precursor sheet forms the bottom plate of the integral thermal transfer panel and the integral thermal transfer panel defines a flow channel having a first port and a second port.

12. The method of claim 10, wherein the integral thermal transfer panel includes a top surface, a bottom surface and a peripheral wall connecting the top surface to the bottom surface and the first port and the second port are located in the peripheral wall;

13. The method of claim 10, wherein the integral thermal transfer panel includes a top surface, a bottom surface and a peripheral wall connecting the top surface to the bottom surface and the first port and the second port are located in one of the top surface and the bottom surface.
